(19) United States
(12) Patent Application Publication
(10) Pub. No.: US 2003/0111594 A1
(43) Pub. Date: Jun. 19, 2003

(54) Optical device and optical process for particle displacement

(75) Inventors: Stephane Getin, Grenoble (FR); Patrick Chaton, Theys (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, PARIS (FR)

(21) Appl. No.: 10/310,767

(22) Filed: Dec. 6, 2002

(30) Foreign Application Priority Data
Dec. 13, 2001 (FR) 0116117

(51) Int. Cl. H05H 3/04

(52) U.S. Cl. 250/251

(57) ABSTRACT

The invention relates to an optical device and an optical process for displacement of particles (P).

The device comprises a substrate (6) on which at least one strip (5) of at least one thin layer is deposited, the strip (5) having an optical thickness gradient along an axis such that the displacement of a particle (P) takes place along this axis when an electromagnetic wave (L) illuminates the device.

The invention is applicable to sorting and/or analysis of particles.

### DESCRIPTION

1. Technical field and prior art

The invention relates to an optical device for the displacement of particles and a particle switching device, a particle sorting device and a particle analysis device comprising an optical device for displacement of particles according to the invention.

The invention also relates to an optical process for displacement of particles and a particle switching process, a particle sorting process and a particle analysis process comprising an optical process for displacement of particles according to the invention.

The invention is applicable to sorting and/or analysis of small particles. For example, the particles may be cells, macromolecules or microballs. Application fields include chemical or biomedical analysis, or quality control (calibration of microparticles).

Different means for the displacement of small particles are known. A first means is described in the document entitled “Observation of Radiation-Pressure Trapping of particles by Alternating Light Beams” (A. Ashkin and J. M. Dziedzic; Physical Review Letters, vol. 54, No. 12, Mar. 25, 1985). This first means, commonly called an “optical clamp” is shown in FIG. 1. A particle P placed on a support 1 is confined in the waist of a continuous laser beam 2. Confinement is made possible by balancing of radiation pressures at the surface of support 1. Once confinement has been achieved, the particle is displaced by displacement of the beam. This device has one main disadvantage: displacement of the particles is based on use of a dedicated mechanical system that may be difficult and expensive to implement.

A second means of displacing particles according to known art is described in the document entitled “Movement of micrometer-sized particles in the evanescent field of a laser beam” (Satoshi Kawata and Tadao Sugiura; Optics Letters/Vol. 17, No. 11, Jun. 1, 1992). FIG. 2 illustrates this second means. A light beam 4 is injected into a strip guide 3. The particle P is then confined at the surface of the guide by the set of radiation pressures exerted on it. An evanescent wave present at the interfaces of the guide enables the particle displacement along the axis of the strip. This device is not adapted to particle switching since it is not easy to make multiplexing/demultiplexing functions in the field of wave guides. These functions are carried out using shutters or optomechanical switches that are difficult to make.

The invention does not have these disadvantages.

### DESCRIPTION OF THE INVENTION

The invention relates to an optical device for particle displacement. The device comprises a substrate on which at least one strip of at least one thin layer is deposited, the strip having an optical thickness gradient along an axis such that a particle is displaced along this axis when an electromagnetic wave illuminates the device. The optical thickness is the path followed by the light. The optical thickness is equal to the product n×e, where n is the optical index of the material and e is the physical thickness of the material.

The invention also relates to a particle switching device, characterized in that it comprises at least one optical device for displacement of particles according to the invention.

The invention also relates to a particle sorting device, characterized in that it comprises at least one particle switching device according to the invention.

The invention also relates to a particle analysis device, characterized in that it comprises at least one particle sorting device according to the invention.

The invention also relates to an optical process for displacement of particles along an axis. The process includes the formation of a stationary wave intensity gradient at a particle to be displaced, by illumination using an electromagnetic wave, a substrate on which at least one strip of at least one thin layer is deposited, with an optical thickness gradient along the axis.

The invention also relates to a particle switching process from a first channel to a second channel, characterized in that the displacement of a particle on a channel is made using the displacement process according to the invention and in that the particle is switched by modifying the wave length of the wave that illuminates the substrate from a first value to a second value, the first value being a value on which the first channel, composed of a first strip deposited on the substrate, is centered, and the second value being a value on which the second channel, composed of a second strip deposited on the substrate, is centered.

The invention also relates to a particle sorting process, characterized in that it makes use of a switching process according to the invention.

The invention also relates to a particle analysis process, characterized in that it uses a sorting process according to the invention.

The size of particles that can be displaced may vary from a few tens of nanometers to several tens of microns. Distances on which particles can be moved can vary from a few microns to a few centimeters.

### BRIEF DESCRIPTION OF THE FIGURES

Other characteristics and advantages of the invention will be understood more clearly upon reading a preferred embodiment of the invention described with reference to the appended figures wherein:

FIG. 1 represents a particle displacement means of the “optical clamp” type according to prior art;

FIG. 2 shows a particle displacement means by evanescent wave according to prior art;

FIGS. 3A and 3B represent an optical device for displacement of particles according to the invention;

FIG. 4 represents an improvement to the optical device for displacement of particles according to the invention;

FIGS. 5A and 5B represent curves illustrating the correlation between the variation of the electrical field at the surface of the optical device according to the invention and the particle displacement speed;

FIG. 6 represents an example of an optical particle switching device according to the invention;

FIG. 7 represents an example of a particle analysis device according to the invention.

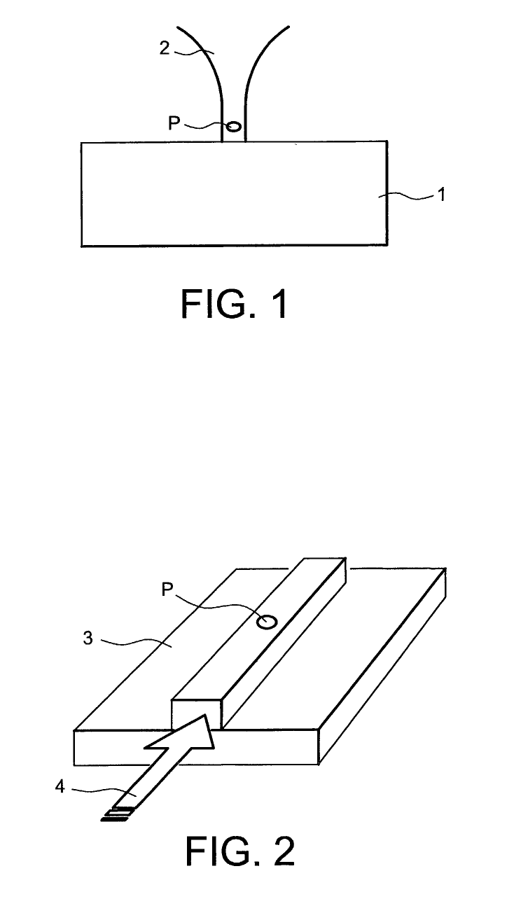

The same references in all figures denote the same elements.

### DETAILED DESCRIPTION OF EMBODIMENTS OF THE INVENTION

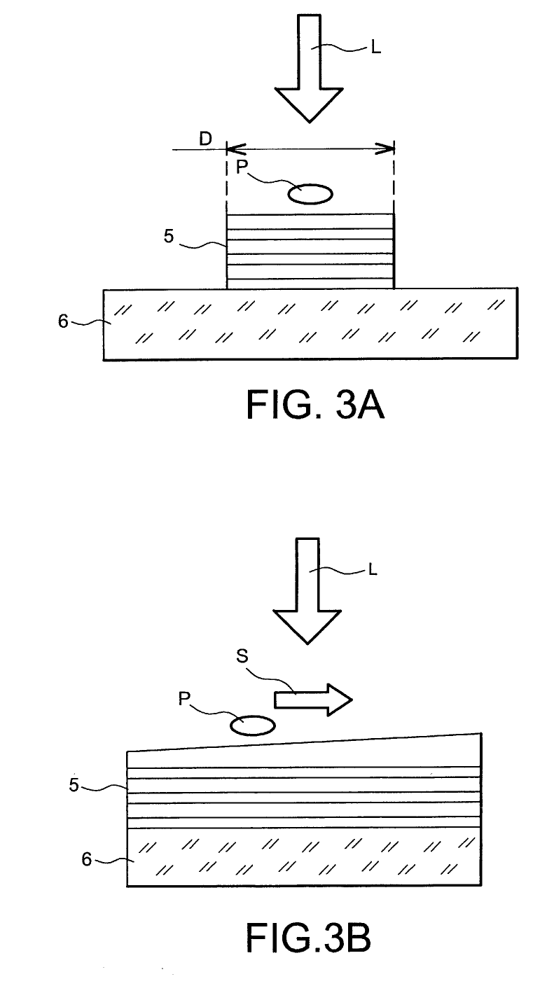

FIGS. 3A and 3B represent a cross sectional view and a longitudinal sectional view respectively of an optical device for displacement of particles according to the invention.

The device comprises a substrate 6 and a strip 5 formed from at least one thin layer deposited on the substrate 6. The width of the strip 5 is equal to D and its thickness e varies along the axis perpendicular to its width. The variation of the thickness may be continuous, as shown in FIG. 3B. It may also be varied in steps. For example, the substrate 6 may be a glass substrate or a silicon substrate. The layers that make up the strip 5 may be composed by alternating a material with a high index (Si, HfO₂, TiO₂, Si₃N₄, Al₂O₃, Ta₂O₅, SiO₂, MgF₂, ITO, In₂O₃, InP) and a material with a low index (SiO₂, MgF₂, LiF). They may be made by Physical Vapor Deposition (PVD), by Chemical Vapor Deposition (CVD) or by a sol-gel method.

A particle P that is to be displaced is placed on the strip 5. The substrate 6 is illuminated in its entirety by light L, for which the wave length can vary, for example, from the infrared range to the ultraviolet range. Interference between incident light L and light reflected by the device (substrate+strip) then leads to the formation of a stationary wave at the surface of the device.

The strip 5 is made from one or more of the materials with given refraction indexes. The variation of the thickness of the strip 5 along its longitudinal axis produces an optical thickness gradient along this axis. This optical thickness gradient creates an intensity gradient of the stationary wave in which the particle P is located. The particle P is then moved under the effect of the variation in the radiation pressure applied to it. The particle P moves longitudinally along the axis of the strip 5, from lower thicknesses towards higher thicknesses (direction of the displacement S in FIG. 3B). The direction of displacement of the particle (towards the left or towards the right) depends on the stack structure (layer indexes and thicknesses).

According to the embodiment of the invention described above, the optical thickness gradient is obtained by varying the thickness of the strip 5. The invention also relates to other embodiments. Thus, for example, the invention relates also to a structure in which the thickness of the strip 5 is constant. In this case the variation of the index of the material itself, or the materials themselves, creates the optical thickness gradient. It is also possible to advantageously combine the two solutions (index variation and thickness variation) to obtain the required optical thickness variations.

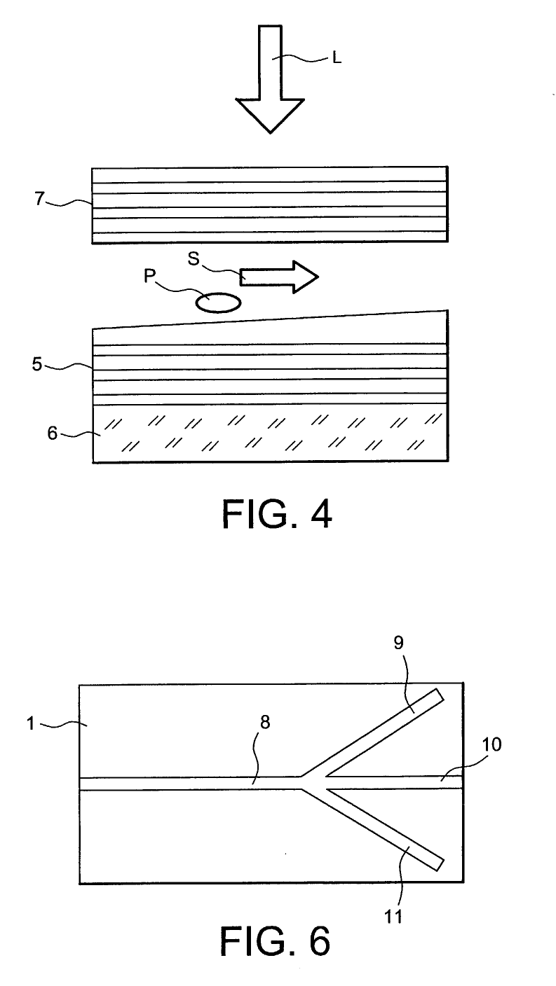

FIG. 4 represents an improvement to the optical particle displacement device according to the invention.

A structure 7 composed of at least one thin layer is placed above the strip 5 such that the strip 5 and the structure 7 form a Fabry-Perot cavity. For example, the composition of the layers of the structure 7 may be identical to the composition of the layers of the strip 5. By making the average distance between the strip 5 and the structure 7 equal to an integer multiple of half of the wave length used, the intensity of the wave on the inside of the cavity can be increased by resonance. Reflectivities of the strip 5 and the structure 7 are then chosen such that a resonance peak is located at particle P.

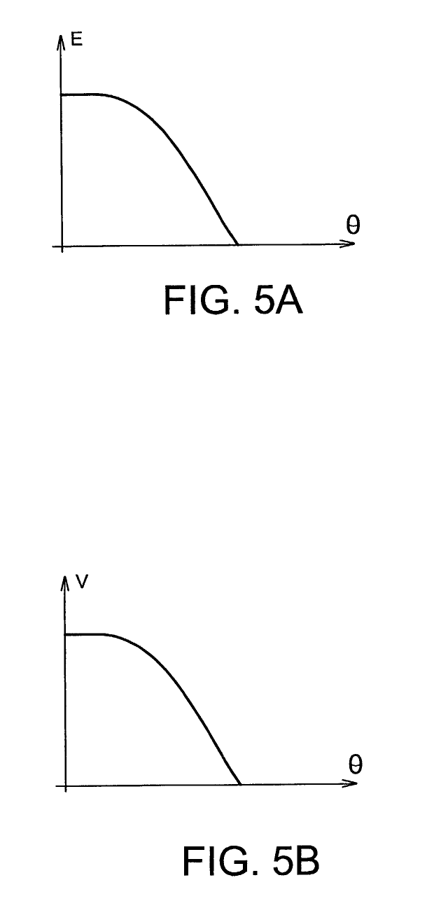

The value of the light intensity at particle P controls the particle displacement velocity. The device according to the invention advantageously controls the particle velocity. FIGS. 5A and 5B show the intensity of the electrical field E and the velocity V of the particle respectively, as a function of the angle of incidence θ of the wave that illuminates the device. It can be seen that the intensity of the electrical field and the particle velocity vary in the same way. For a zero incidence wave, the intensity of the field and the particle velocity are maximized, and the field intensity and the particle velocity reduce when the angle of incidence increases.

As already mentioned, apart from an optical device for particle displacement, the invention also relates to:

an optical switching device comprising at least one optical device for displacement of particles according to the invention;

a particle sorting device comprising at least one optical switching device according to the invention; and

a particle analysis device comprising at least one particle sorting device according to the invention.

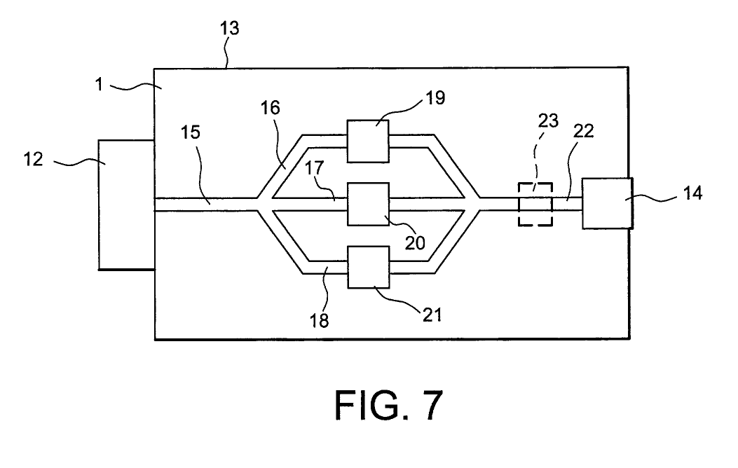

FIGS. 6 and 7 illustrate these various devices as non limitative examples.

FIG. 6 represents a top view of an optical particle switching device according to the invention. Four strips of thin layers 8, 9, 10 and 11 are deposited on a substrate 1. The strip 8 is divided into three strips 9, 10 and 11. The strips 8, 9, 10 and 11 are centered for example on wave lengths λ1, λ2, λ1, λ3 respectively, where λ1, λ2 and λ3 are three different wave lengths such that λ3>λ2>λ1. The strips are centered on the different wave lengths in a known manner, choosing the reflectivity of the materials and optimizing the thickness and the number of layers. With reference to FIG. 6, the direction of displacement of particles on strips 8, 9, 10 and 11 is from the left of the figure towards the right of the figure.

When the device is illuminated by a wave with a wave length λ1, a particle P moves along strip 8 and then strip 9. When the device is illuminated by a wave with a wave length λ1 and then by a wave with a wave length λ2, a particle P moves along strip 8 and then strip 10. Finally, when the device is illuminated by a wave with wave length λ1 then λ3, a particle P moves on strip 8 and then strip 11 in sequence.

In the case of a polychromatic source, the routing may be done by modifying the incidence of the wave from the normal. The effect of the incidence of the wave is a means of offsetting the spectral function of the wave length λ3 towards the wave length λ1. Thus, as the incidence increases, particles follow channels 11, 9 and 10 in sequence. One advantageous embodiment is to use the polarization of the wave that illuminates the device. A polarization parallel to the plane of incidence is then used, which gives better spectral separation of channels 9, 10 and 11.

The switching device shown in FIG. 6 forms a junction between one channel and n channels (n=3). Symmetrically, the invention also relates to a junction type switching device between n channels and one channel, as will be shown below.

FIG. 7 represents an example particle analysis device according to the invention. The device comprises a dispenser 12, an analysis block 13 and a read device 14. The analysis block 13 comprises a substrate 1, a first switching device from one input channel 15 towards three channels 16, 17, 18, three analysis circuits 19, 20, 21, a second switching device from the three channels 16, 17, 18 to one output channel 22 and a laser 23. The analysis circuits 19, 20, 21 are read circuits, for example with reinforced fluorescence. Each switching device operates as described above. The dispenser 12 provides the particles to be analyzed. A first series of measurements can then be deduced from the analyses carried out by circuits 19, 20 and 21.

The laser 23 that illuminates the output channel 22, can be used to break particles if necessary. Pieces of particles thus obtained are transferred as far as the read device 14 which then makes a series of measurements on pieces of particle.

1. Optical device for displacement of particles (P) characterized in that it comprises a substrate (6) on which at least one strip (5) of at least one thin layer is deposited, the strip (5) having an optical thickness gradient along an axis such that the displacement of a particle (P) takes place along this axis when an electromagnetic wave (L) illuminates the device.

2. Device according to claim 1, characterized in that the thickness (e) of the strip (5) varies along the direction of the axis.

3. Device according to claim 1, characterized in that the strip (5) is composed of materials for which the index varies along the direction of the axis.

4. Device according to claim 1, characterized in that it comprises a structure (7) composed of at least one thin layer placed facing the strip (5) such that the strip (5) and the structure (7) form a Fabry-Perot cavity.

5. Device according to claim 4, characterized in that the distance between the strip (5) and the structure (7) is equal to an integer multiple of half the wave length that illuminates the device so as to increase the intensity of the wave inside the cavity by resonance.

6. Device according to claim 5, characterized in that the reflectivities of the strip (5) and the structure (7) are chosen such that a resonance peak occurs at the location of a particle.

7. Device according to claim 1, characterized in that the strip (5) is composed of an alternation of high index layers and low index layers.

8. Device according to claim 4, characterized in that the structure (7) is composed of an alternation of high index layers and low index layers.

9. Device according to claim 7, characterized in that the high index layers are made from a material chosen from among Si, HfO₂, TiO₂, Si₃N₄, Al₂O₃, Ta₂O₅, ITO, In₂O₃, SiO₂, MgF₂, or InP.

10. Device according to claim 7, characterized in that the low index layers are made from a material chosen from among SiO₂, MgF₂, or LiF.

11. Particle switching device from a first channel to a second channel, characterized in that it comprises at least two optical devices for displacement of particles according to any one of claims 1 to 10, each optical device forming one channel.

12. Particle switching device according to claim 11, characterized in that each optical device comprising one channel comprises a strip (8, 9, 10, 11) of at least one thin layer, each strip being centered at a given wave length (λ1, λ2, λ3) and with an optical thickness gradient along an axis such that a particle is displaced along this axis when the device is illuminated by an optical wave with a wave length equal to the wave length on which the strip is centered.

13. Particle sorting device, characterized in that it comprises at least one switching device according to one of claims 11 or 12.

14. Particle analysis device, characterized in that it comprises at least one particle sorting device according to claim 13.

15. Particle analysis device according to claim 14, characterized in that it comprises a particle switching device making a junction between an input channel (15) and n intermediate channels (16, 17, 18) and a switching device making a junction between the said n intermediate channels (16, 17, 18) and an output channel (22), an analysis device (19, 20, 21) being placed on at least one intermediate channels among the n channels (16, 17, 18).

16. Device according to claim 15, characterized in that the analysis device is an analysis device based on fluorescence.

17. Analysis device according to claim 15, characterized in that it comprises a laser (23) to illuminate the output channel (22) and break particles that move in it, and a read device (14) to analyze the pieces of the broken particles.

18. Optical particle displacement process along an axis, characterized in that it comprises the formation of a stationary wave intensity gradient at a particle to be displaced, by illumination, using an electromagnetic wave, of a substrate (1) on which at least one strip (5) is deposited, comprising at least one thin layer with an optical thickness gradient along the axis.

19. Process according to claim 18, characterized in that the particle displacement velocity is modified by varying the incidence of the electromagnetic wave on the substrate.

20. Particle switching process from a first channel to a second channel, characterized in that a particle is displaced on a channel using the process according to claim 18 and in that a particle is switched by modifying the wave length of the wave that illuminates the substrate (1) from a first value (λ1) to a second value (λ2), the first value being a value on which the first channel that is composed of a first strip (8) of at least one thin layer deposited on the substrate (1) is centered, and the second value being a value on which the second channel, that is composed of a second strip (9) of at least one thin layer deposited on the substrate, is centered.

21. Particle sorting process, characterized in that it uses a switching process according to claim 20.

22. Particle analysis process, characterized in that it uses a sorting process according to claim 21.
